(19) United States
(12) Patent Application Publication
(10) Pub. No.: US 2025/0163597 A1
(43) Pub. Date: May 22, 2025

(54) ELECTROLYZER SYSTEM INCLUDING SINGLE MASS FLOW CONTROLLER FOR MULTIPLE HYDROGEN GENERATION MODULES AND METHOD OF OPERATING THEROF

(71) Applicant: BLOOM ENERGY CORPORATION, San Jose, CA (US)

(72) Inventor: Ali ZARGARI, Santa Clara, CA (US)

(21) Appl. No.: 18/953,912

(22) Filed: Nov. 20, 2024

Related U.S. Application Data
(60) Provisional application No. 63/601,356, filed on Nov. 21, 2023.

(51) Int. Cl. C25B 15/08; C25B 1/042; C25B 9/77; C25B 11/047; C25B 15/02

(52) U.S. Cl. CPC C25B 15/08; C25B 1/042; C25B 9/77; C25B 11/047; C25B 15/02

(57) ABSTRACT

A method of operating an electrolyzer system includes providing steam from a steam source through a system steam conduit to module steam conduits located in respective electrolyzer modules, controlling a flow rate of the steam through the system steam conduit using a system mass flow controller located on the system steam conduit, providing portions of the steam to the module steam conduits and providing steam in the module steam conduits to respective stacks of electrolyzer cells located in respective hotboxes in the respective electrolyzer modules, and operating the stacks to generate a hydrogen product stream and an oxygen exhaust stream.

### FIELD

The present disclosure is generally directed to electrolyzer systems, and specifically to electrolyzer cell systems including a single mass flow controller for plural hydrogen generation modules and methods of operating the same.

### BACKGROUND

In a solid oxide electrolyzer cell (SOEC), a cathode electrode is separated from an anode electrode by a solid oxide electrolyte. When a SOEC is used to produce hydrogen through electrolysis, a positive potential is applied to the air side of the SOEC and oxygen ions are transported from the fuel (e.g., steam) side to the air side. Throughout this specification, the SOEC anode will be referred to as the air electrode, and the SOEC cathode will be referred to as the fuel electrode. During SOEC operation, water (e.g., steam) in the fuel stream is reduced (H₂O+2e⁻→O²⁻+H₂) to form H₂ gas and O²⁻ ions, the O²⁻ ions are transported through the solid electrolyte, and then oxidized (e.g., by an air inlet stream) on the air side (O²⁻ to O₂) to produce molecular oxygen (e.g., oxygen enriched air).

### SUMMARY

In various embodiments, a method of operating an electrolyzer system includes providing steam from a steam source through a system steam conduit to module steam conduits located in respective electrolyzer modules, controlling a flow rate of the steam through the system steam conduit using a system mass flow controller located on the system steam conduit, providing portions of the steam to the module steam conduits and providing steam in the module steam conduits to respective stacks of electrolyzer cells located in respective hotboxes in the respective electrolyzer modules, and operating the stacks to generate a hydrogen product stream and an oxygen exhaust stream.

In various embodiments, an electrolyzer system comprises a system steam conduit configured to receive steam from a steam source; a system steam MFC located on the system steam conduit configured to control steam flow through the system steam conduit; and electrolyzer modules. Each of the electrolyzer modules comprises: a hotbox comprising a stack of electrolyzer cells configured receive a portion of the steam and configured to receive air, and wherein the stack outputs a hydrogen product stream and an oxygen exhaust stream during steady-state operation, and a module steam conduit fluidly connecting the system steam conduit to the hotbox.

### FIGURES

FIG. 1A is a perspective view of a solid oxide electrolyzer cell (SOEC) stack, and FIG. 1B is a side cross-sectional view of a portion of the stack of FIG. 1A.

FIG. 2 is a schematic view of a portion of an electrolyzer system, according to various embodiments of the present disclosure.

FIG. 3A is a schematic view of an electrolyzer module that may be included in the electrolyzer system of FIG. 2, and FIG. 3B is a schematic view of a steam flow restrictor that may be included in the system of FIG. 2.

### DETAILED DESCRIPTION

The various embodiments will be described in detail with reference to the accompanying drawings. The drawings are not necessarily to scale and are intended to illustrate various features of the invention. Wherever possible, the same reference numbers will be used throughout the drawings to refer to the same or like parts. References made to particular examples and implementations are for illustrative purposes and are not intended to limit the scope of the invention or the claims.

Ranges can be expressed herein as from “about” one particular value, and/or to “about” another particular value. When such a range is expressed, examples include from the one particular value and/or to the other particular value. Similarly, when values are expressed as approximations, by use of the antecedent “about” or “substantially” it will be understood that the particular value forms another aspect. In some embodiments, a value of “about X” may include values of +/−1% X. It will be further understood that the endpoints of each of the ranges are significant both in relation to the other endpoint, and independently of the other endpoint.

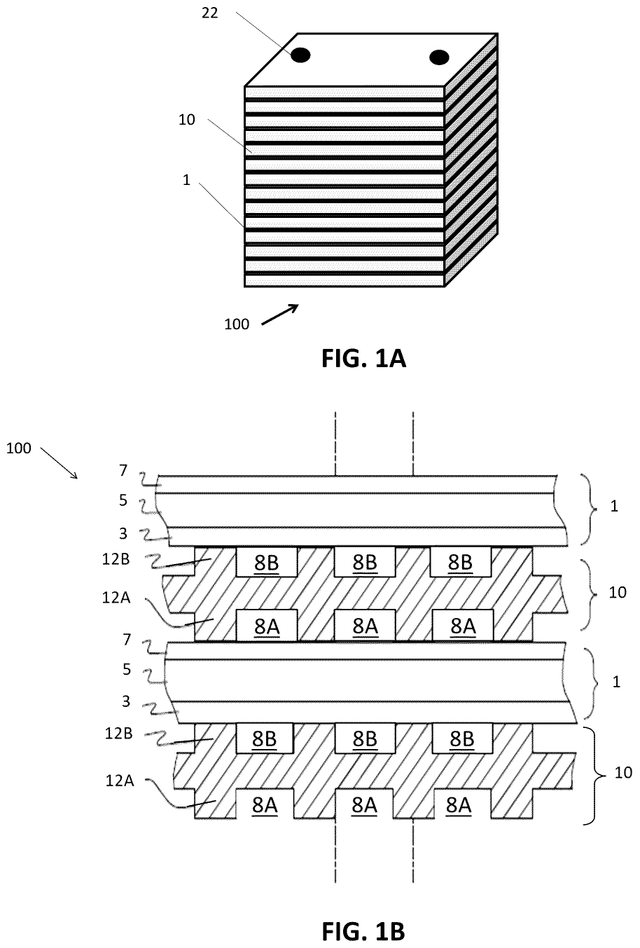

FIG. 1A is a perspective view of an electrolyzer cell stack 100, such as a solid oxide electrolyzer cell (SOEC) stack, and FIG. 1B is a side cross-sectional view of a portion of the stack 100 of FIG. 1A. Referring to FIGS. 1A and 1B, the stack 100 includes multiple electrolyzer cells (e.g., SOECs) 1 that are separated by interconnects 10, which may also be referred to as gas flow separator plates or bipolar plates. Each electrolyzer cell 1 includes an air electrode 3, an electrolyte 5, such as a solid oxide electrolyte for a SOEC, and a fuel electrode 7. The stack 100 also includes internal fuel riser channels 22.

Each interconnect 10 electrically connects adjacent electrolyzer cells 1 in the stack 100. In particular, an interconnect 10 may electrically connect the fuel electrode 7 of one electrolyzer cell 1 to the air electrode 3 of an adjacent electrolyzer cell 1. FIG. 1B shows that the lower electrolyzer cell 1 is located between two interconnects 10.

Various materials may be used for the air electrode 3, electrolyte 5, and fuel electrode 7. For example, the air electrode 3 may comprise an electrically conductive material, such as an electrically conductive perovskite material, such as lanthanum strontium manganite (LSM). Other conductive perovskites, such as LSCo, etc., or metals, such as Pt, may also be used. The electrolyte 5 may comprise a stabilized zirconia, such as scandia stabilized zirconia (SSZ) or yttria stabilized zirconia (YSZ), yttria-ceria-stabilized zirconia (YCSZ), ytterbia-ceria-scandia-stabilized zirconia (YbCSSZ) or blends thereof. In YbCSSZ, scandia may be present in an amount equal to 9 to 11 mol %, such as 10 mol %, ceria may present in amount greater than 0 and equal to or less than 3 mol %, for example 0.5 mol % to 2.5 mol %, such as 1 mol %, and ytterbia may be present in an amount greater than 0 and equal to or less than 2.5 mol %, for example 0.5 mol % to 2 mol %, such as 1 mol %, as disclosed in U.S. Pat. No. 8,580,456, which is incorporated herein by reference. Alternatively, the electrolyte 5 may comprise another ionically conductive material, such as a doped ceria. The fuel electrode 7 may comprise a cermet comprising a nickel containing phase and a ceramic phase. The nickel containing phase may consist entirely of nickel in a reduced state. The ceramic phase may comprise a stabilized zirconia, such as yttria and/or scandia stabilized zirconia and/or a doped ceria, such as gadolinia, yttria and/or samaria doped ceria. The electrodes and the electrolyte may each comprise one or more sublayers of one or more of the above described materials.

Each interconnect 10 includes fuel ribs 12A that at least partially define fuel channels 8A, and air ribs 12B that at least partially define air channels 8B. The interconnect 10 may operate as a gas-fuel separator that separates a fuel, such as steam, flowing to the fuel electrode 7 of one electrolyzer cell 1 in the stack 100 from oxidant, such as air, flowing to the air electrode 3 of an adjacent electrolyzer cell 1 in the stack 100. At either end of the stack 100, there may be an air end plate or fuel end plate (not shown) for providing air or fuel, respectively, to the end electrode. Alternatively, the air end plate or fuel end plate may comprise the same interconnect structure used throughout the stack.

Each interconnect 10 may be made of or may contain electrically conductive material, such as a metal alloy (e.g., chromium-iron alloy) which has a similar coefficient of thermal expansion to that of the solid oxide electrolyte in the cells (e.g., a difference of 0-10%). For example, the interconnects 10 may comprise a metal (e.g., a chromium-iron alloy, such as 4-6 weight percent iron, optionally 1 or less weight percent yttrium and balance chromium alloy). Alternatively, any other suitable conductive interconnect material, such as stainless steel (e.g., ferritic stainless steel, SS446, SS430, etc.) or iron-chromium alloy (e.g., Crofer™ 22 APU alloy which contains 20 to 24 wt. % Cr, less than 1 wt. % Mn, Ti and La, and balance Fe, or ZMG™ 232L alloy which contains 21 to 23 wt. % Cr, 1 wt. % Mn and less than 1 wt. % Si, C, Ni, Al, Zr and La, and balance Fe).

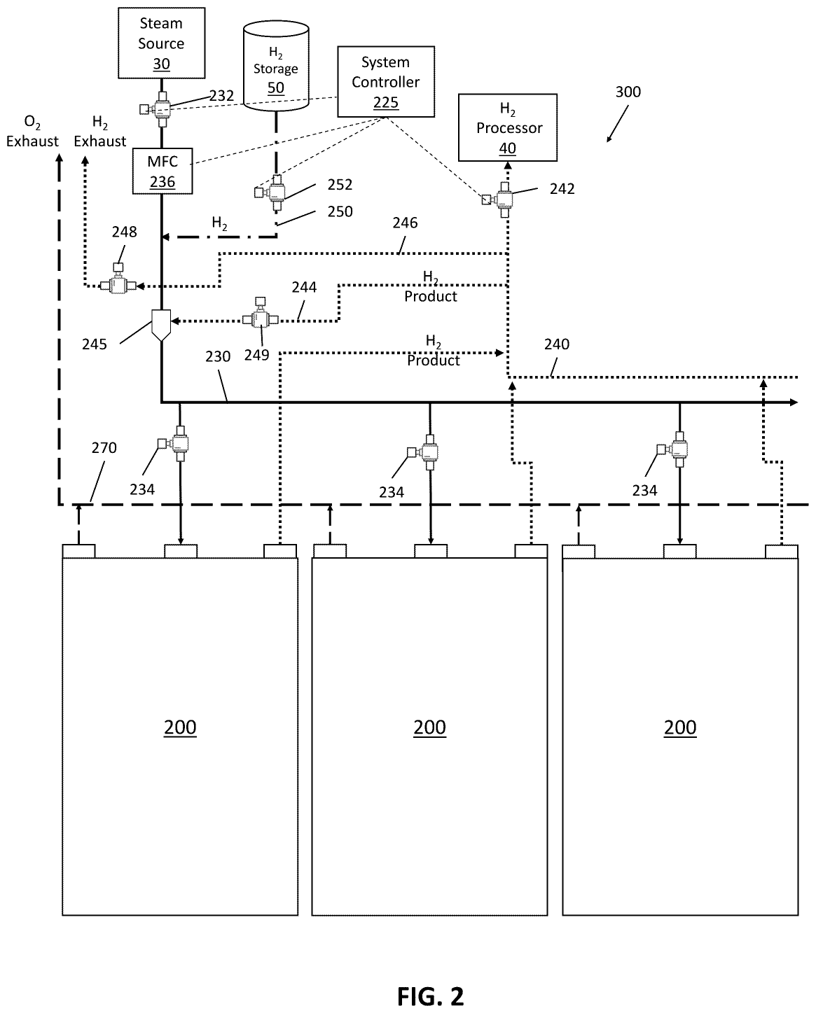

FIG. 2 is a schematic view of a portion of an electrolyzer system 300, according to various embodiments of the present disclosure. Referring to FIG. 2, the system 300 may include multiple fluidly connected modules 200. The modules 200 may comprise electrolyzer modules (e.g., hydrogen generation modules) which generate a hydrogen product from electrolysis of water (e.g., steam). While three modules 200 are shown, the system 300 may include any suitable number of modules 200. The system 300 may include a steam conduit (e.g., a pipe, header or manifold) 230 configured to fluidly connect each module 200 to a steam source 30, a product conduit (e.g., a pipe, header or manifold) 240 configured to fluidly connect each module 200 to a hydrogen processor 40, a hydrogen conduit (e.g., a pipe, header or manifold) 250 configured to fluidly connect a hydrogen storage vessel (e.g., hydrogen tank) 50 to the steam conduit 230, and an exhaust conduit (e.g., a pipe, header or manifold) 270 configured to receive oxygen exhaust from the modules 200. The steam source 30 may comprise any suitable source of steam, such as a building or factory steam source (e.g., external boiler, etc.), which provides byproduct steam to the steam conduit 230, and/or a dedicated steam generator which is part of the system 300. The hydrogen processor 40 may comprise any component which may compress and/or store the hydrogen product, such as a mechanical compressor, an electrochemical hydrogen separator (e.g., a proton exchange membrane), and/or a hydrogen storage vessel.

The system 300 may also include a system controller 225, an optional system recycling conduit 244, an optional vent conduit 246, and an optional ejector 245. The ejector 245 may be located on the steam conduit 230, and the system recycling conduit 244 may fluidly connect the product conduit 240 to the ejector 245 located on the steam conduit 230. The vent conduit 246 may fluidly connect the product conduit 240 to an individual module exhaust or to a common system exhaust conduit which is fluidly connected to the vent conduits 246 of all modules. The ejector 245 may operate to pull a portion of the hydrogen product stream from the product conduit 240 through the system recycling conduit 244 and into the steam conduit 230 to recycle a portion of the hydrogen product stream back into the modules 200, while a remaining portion of the hydrogen product stream is provided to the hydrogen processor 40. In some embodiments, the ejector 245 may be replaced with a system recycle blower.

The system 300 may also include various flow control elements to control fluid flow to and/or from the modules 200. For example, the system 300 may include a system steam mass flow controller 236 configured to control steam flow from the steam source 30 through the steam conduit 230. The system may also include an optional primary steam valve 232 located on the steam conduit 230 and configured to shut off and turn on the flow from the steam source 30 through the steam conduit 230. The system may also include optional module shutoff valves 234 located between the steam conduit 230 and the respective modules 200 and configured to control the steam flow from the steam conduit 230 into the respective modules 200. The system 300 may also include a product valve 242 located on the product conduit 240 and configured to control hydrogen product flow from the product conduit 240 into the hydrogen processor 40. The system 300 may also include an optional recycling valve 249 located on the optional system recycling conduit 244 and configured to control a flow of a portion of the hydrogen product stream through the system recycling conduit 244. The system 300 may also include a hydrogen valve 252 located on the hydrogen conduit 250 and configured to control hydrogen flow from the hydrogen storage vessel 50 into the hydrogen conduit 250. The hydrogen valve 252 may be opened during system startup and shutdown modes to provide hydrogen from the hydrogen storage vessel 50 to the modules 200, and closed during a steady-state operating mode of the system 300 during which the system 300 generates the hydrogen product. The system 300 may also include a vent valve 248 located on the vent conduit 246 and configured to control hydrogen product flow through the vent conduit 246. For example, the vent valve 248 may be opened during system shutdown to vent the product conduit 240 and depressurize the system 300. In some embodiments, one or more of the valves may comprise gas solenoid valves or other suitable valves.

The system controller 225 may include a central processing unit and a memory. The system controller 225 may be wired or wirelessly connected to various elements of the system 300, and may be configured to control the same. For example, the system controller 225 may be configured to control the system steam mass flow controller 236, the various valves and the operation of the modules 200. In one embodiment, the system controller 225 may be located in a power module which includes a housing separate from the housings of the electrolyzer modules 200. The power module may also include an AC/DC rectifier configured to convert alternating current (AC) power from a power source (e.g., power grid) to direct current (DC) power provided to the electrolyzer modules 200. The remaining components of the system 300 may be located either in a gas distribution module which includes a housing separate from the housings of the electrolyzer modules 200 and the power module, and/or outside the module housings of the system 300. For example, the primary steam control valve 232, the system steam mass flow controller 236, the steam source 30 and/or the hydrogen processor 40 may be located in the gas distribution module and/or separate from the module housings of the system 300. Likewise, the steam conduit 230 may extend from the gas distribution module to the electrolyzer modules 200 in or over a common base supporting the gas distribution module and the electrolyzer modules 200.

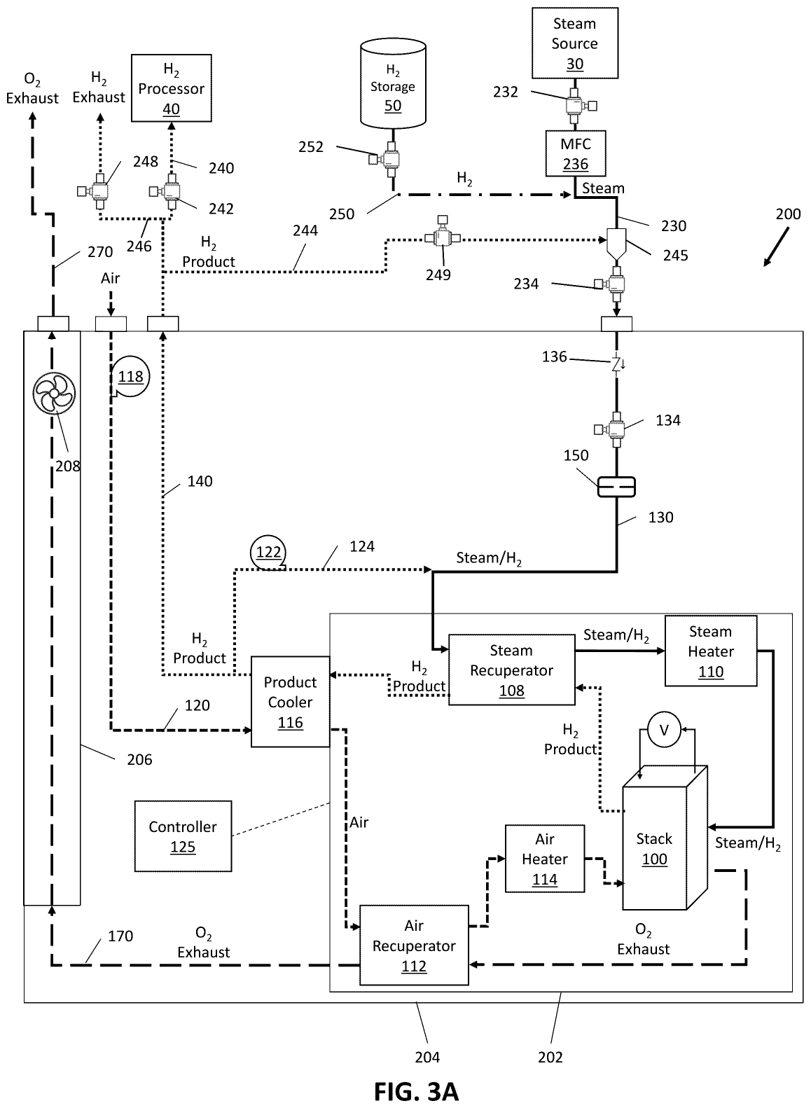

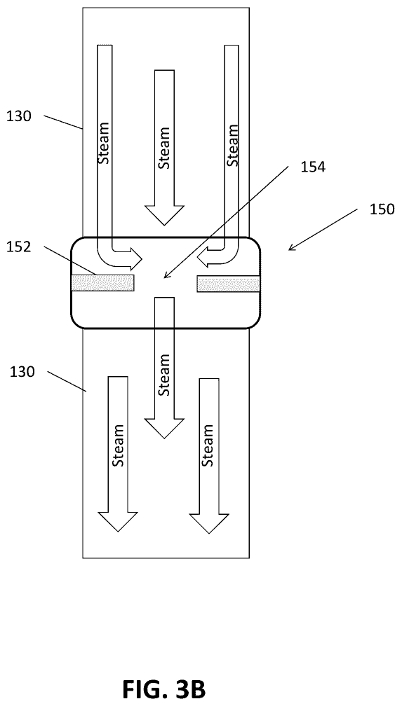

FIG. 3A is a schematic view of an electrolyzer module 200 that may be included in the electrolyzer system 300 of FIG. 2, according to various embodiments of the present disclosure. Referring to FIGS. 1A, 1B, 2 and 3A, each module 200 may include an electrolyzer cell stack 100 including multiple electrolyzer cells, such as solid oxide electrolyzer cells (SOECs), as described with respect to FIGS. 1A and 1B. The stack 100 may be located in an electrolyzer cell column including plural stacks. Alternatively, the column may contain only a single stack 100. The module 200 may also include a steam recuperator heat exchanger 108, one or multiple steam heaters 110, an air recuperator heat exchanger 112, and one or multiple air heaters 114. The module 200 may also include an optional product cooler/air preheater heat exchanger 116, and an optional stack heater (not shown for clarity).

The module 200 may include a hotbox 202 to house various components, such as the stack 100, the steam recuperator 108, the steam heater 110, the air recuperator 112, and/or the air heater 114. In some embodiments, the hotbox 202 may include multiple stacks 100 and/or columns of stacks. The module 200 may also include a cabinet 204 configured to house the hotbox 202 and other module 200 components located outside of the hotbox 202. Optionally, the module 200 may also include a controller 125, such as a central processing unit, which is configured to control the operation of the module 200. For example, the controller 125 may be wired or wirelessly connected to various elements of the module 200 to control the same. Alternatively, the controller 125 may be located outside the housing of the electrolyzer module 200 (e.g., in the power module of the system 300). The product cooler/air preheater heat exchanger 116 can be located inside the hotbox 202, or it can be located outside of the hotbox 202.

During operation, the stack 100 may be provided with steam from the steam source 30 and may be provided with electric power (e.g., DC current or voltage) from an external power source, such as a power grid. In particular, the steam may be provided to the fuel electrodes 7 of the electrolyzer cells 1 of the stack 100, and the power source may apply a voltage between the fuel electrodes 7 and the air electrodes 3, in order to electrolyze water molecules at the fuel electrodes 7 to form hydrogen gas and oxygen ions. In SOECs 1, the oxygen ions are transported through the solid electrolyte 5 to the air electrodes 3. Air may optionally be provided to the air electrodes 3 of the stack 100, in order to sweep the oxygen from the air electrodes 3. The stack 100 may output a hydrogen stream (e.g., hydrogen product which may also contain residual steam) into a module product conduit 140, and an oxygen-rich exhaust stream (e.g., an oxygen exhaust stream), such as an oxygen-rich air stream (i.e., oxygen enriched air) into a module exhaust conduit 170.

The steam output from the steam source 30 may be provided to the multiple modules 200 via the steam conduit 230. The steam entering a module 200 from the steam conduit 230 may be provided to the steam recuperator 108 via a module steam conduit 130. The steam may include small amounts of dissolved air and/or oxygen. As such, the steam may be mixed with hydrogen gas, in order to maintain a reducing environment in the stack 100, and in particular, at the fuel electrodes 7. A shutoff valve 134, an optional non-return valve 136 and an optional flow restrictor 150 may be located on module steam conduit 130. The shutoff valve 134 may comprise any suitable valve type, such as a pneumatic steam control valve that is operated using an instrument air conduit provided to the valve from an instrument air source. The non-return valve 136 is configured to prevent the backflow of steam from the module steam conduit 130 into the steam conduit 230. However, in some embodiments, the non-return valve 136 may be omitted. For example, operation of the shutoff valve 134 may be sufficient to prevent steam backflow.

Referring to FIG. 3B, the flow restrictor 150 may include a restrictor plate 152 having an orifice 154 configured to restrict steam flow. In other embodiments, the restrictor plate 152 may include multiple orifices 154 configured to restrict steam flow. As such, the flow restrictor 150 may be configured to create a first amount of pressure drop in steam passing through the at least one orifice 154. In other words, the flow restrictor 150 may be configured to provide a consistent (e.g., constant) steam flow rate to the hotbox 202 at a given constant incoming steam pressure.

Hydrogen may be provided to the steam conduit 230 from the hydrogen storage vessel 50 and/or from a portion of the hydrogen product generated by the stack 100. The hydrogen addition rate may be set to provide an amount of hydrogen that exceeds an amount of hydrogen needed to react with an amount of oxygen dissolved in the steam. The hydrogen addition rate may either be fixed or set to a constant water to hydrogen ratio. However, if the steam is formed using water that is fully deaerated, the hydrogen addition may optionally be omitted.

In some embodiments, the hydrogen may be provided by the external hydrogen storage vessel 50 during system startup and shutdown. For example, during the system 300 startup and/or shutdown modes, hydrogen may be provided from the hydrogen storage vessel 50 to the steam conduit 230 via the hydrogen conduit 250. In contrast, during the steady-state operation mode, a portion of the hydrogen product (i.e., hydrogen exhaust stream) may be diverted from the product conduit 240 to the steam conduit 230 via the recycling conduit 244, and the hydrogen flow from the hydrogen storage vessel 50 may be stopped by closing the shutoff valve 252 on the hydrogen conduit 250.

In some embodiments, the module 200 may include a recycle blower 122 configured to selectively divert a portion of the generated hydrogen product to the steam in the module steam conduit 130. For example, the recycle blower 122 may be located on a module recycling conduit 124 which fluidly connects a module product conduit 140 to the module steam conduit 130. Alternatively, a hydrogen pump may be used instead of the recycle blower 122. In some embodiments, a portion of the generated hydrogen product may be diverted from the module product conduit 140 to the module recycling conduit 124 by a splitter and/or valve.

The steam recuperator 108 may be a heat exchanger configured to recover heat from the hydrogen stream output from the stack 100 into the module product conduit 140. The steam may be heated to at least 600° C., such as 620° C. to 780° C. (depending in part on the stack 100 operating temperature) in the steam recuperator 108.

The steam output from the steam recuperator 108 may be provided to the steam heater 110 which is located downstream from the steam recuperator 108 on the module steam conduit 130, as shown in FIG. 3A. The steam heater 110 may include a heating element, such as a resistive or inductive heating element. The steam heater 110 may be configured to heat the steam to a temperature above the operating temperature of the stack 100. For example, depending on the health of the stack 100, the water utilization rate of the stack 100, and the air flow rate to the stack 100, the steam heater 110 may heat the steam to a temperature ranging from about 700° C. to about 850° C., such as 720° C. to 780° C. Accordingly, the stack 100 may be provided with steam or a steam-hydrogen mixture at a temperature that allows for efficient hydrogen generation. Heat may also be transported directly from the steam heater to the stack by radiation (i.e., by radiant heat transfer). If the stack operating current is sufficiently high to maintain the stack at a desired steady-state operating temperature, then the steam heater and/or the air heater may be turned off. In some embodiments, the steam heater 110 may include multiple steam heater zones with independent power levels (divided vertically, circumferentially, or both), in order to enhance thermal uniformity.

An air blower 118 may provide an air inlet stream to the air recuperator 112 via a module air inlet conduit 120. The module air inlet conduit 120 fluidly connects the air blower 118 to an air inlet of the stack 100 through the product cooler/air preheater heat exchanger 116. The oxygen exhaust output from the stack 100 may be provided via the module exhaust conduit 170 to the air recuperator 112. The air recuperator 112 may be configured to heat the air inlet stream using heat extracted from the oxygen exhaust.

Air output from the air recuperator 112 may be provided to the air heater 114 via a continuation of the air inlet conduit 120 inside the hotbox. The air heater 114 may include a resistive or inductive heating element configured to heat the air to a temperature exceeding the operating temperature of the stack 100. For example, depending on the health of the stack 100, the water utilization rate of the stack 100, and the air flow rate to the stack 100, the air heater 114 may heat the air to a temperature ranging from about 700° C. to about 850° C., such as 720° C. to 880° C. Accordingly, the stack 100 may be provided with air at a temperature that allows for efficient hydrogen generation. Heat may also be transported directly from the air heater to the stack by radiation. In some embodiments, the air heater 114 may include multiple air heater zones with independent power levels (divided vertically or circumferentially or both), in order to enhance thermal uniformity. Air from the air heater 114 is provided to the air electrodes 3 of the stack 100.

Oxygen exhaust (e.g., oxygen enriched air) output from the air recuperator 112 may be provided to the exhaust conduit 270 via the module exhaust conduit 170 and an exhaust duct 206 of the cabinet 204. A fan 208 or multiple fans 208 may optionally be located in the exhaust duct 206 to improve oxygen exhaust flow through the exhaust conduit 270. The exhaust conduit 270 may be configured to receive oxygen exhaust output from multiple modules 200. In some embodiments, the exhaust conduit 270 may provide the exhaust to a chimney or may provide the air exhaust to the atmosphere. In other embodiments, the oxygen exhaust (e.g., oxygen enriched air) may be provided from the exhaust conduit 270 for purification and/or use. In some embodiments, the cabinet 204 may contain a cabinet ventilation fan that comprises the fan 208 or another fan in addition to the fan 208. The cabinet ventilation stream may be merged with the oxygen exhaust stream to lower the temperature and oxygen concentration of the oxygen exhaust stream before exhausting it to the atmosphere.

In some embodiments, the module 200 may include an optional product cooler/air preheater heat exchanger 116, which may be located outside (e.g., on top of) of the hotbox 202 or inside of the hotbox 202. The product cooler/air preheater heat exchanger 116 may be fluidly connected to the hydrogen product conduit 240 by the module product conduit 140. The product cooler/air preheater heat exchanger 116 may be configured to preheat the air inlet stream provided to the hotbox 202 via the module air inlet conduit 120 using heat from the hydrogen product in the module product conduit 140, and to cool a hydrogen product output from the stack 100 using the air inlet stream provided from the air blower 118.

The hydrogen product stream is output from the steam recuperator 108 and the optional product cooler/air preheater heat exchanger 116 via the module product conduit 140 and the product conduit 240 at a temperature of 100° C. to 200° C. The hydrogen product stream may be compressed and/or purified in the hydrogen processor 40, which may include a hydrogen pump (e.g., proton exchange membrane electrochemical pump) that operates at a temperature of from about 40° C. to about 120° C., in order to remove from about 70% to about 90% of the hydrogen from the hydrogen product stream. A remaining water rich stream comprises an unpumped effluent from the hydrogen pump.

In various embodiments, the hydrogen processor 40 may include at least one electrochemical hydrogen pump, liquid ring compressor, diaphragm compressor or combination thereof. For example, the hydrogen processor may include a series of electrochemical hydrogen pumps, which may be located in series and/or in parallel with respect to a flow direction of the hydrogen stream, in order to compress the hydrogen stream. Electrochemical compression may be more electrically efficient than traditional compression. Traditional compression may occur in multiple stages, with interstage cooling and water knockout. The final product from compression may still contain traces of water. As such, the hydrogen processor 40 may include a dewatering device, such as a temperature swing adsorption reactor or a pressure swing adsorption reactor, to remove this residual water, if necessary.

During the system startup mode, the shutoff valve 134 of each module 200 may be opened simultaneously or sequentially. After the shutoff valve 134 is opened, steam from the steam source 30 and hydrogen from the hydrogen storage vessel 50 flow through the module steam conduit 130 and the flow restrictor 150 to the hotbox 202 of each module 200 at a corresponding first steam flow rate. The steam temperature may be at least 110° C., such as 110 to 200° C., for example 130 to 150° C. A relatively high amount of hydrogen may be provided during the system startup mode. The hydrogen may be used to reduce the nickel oxide to nickel in the cermet fuel electrodes 7 of the electrolyzer cells 1.

In general, the hydrogen storage vessel 50 may provide amount of hydrogen that is sufficient to remove oxygen from the steam provided from the steam source 30. However, this may be a relatively small amount of hydrogen, which may not be sufficient to reduce all of the fuel electrodes 7 in all of the hotboxes 202, depending on the type of hydrogen storage vessel 50. In order to generate a sufficiently reducing environment, all of the hydrogen output from the hydrogen storage vessel 50 may be sequentially provided to each module 200 to reduce the fuel electrodes 7 in the respective module. In this embodiment, the shutoff valves 134 are opened sequentially, and the steam and hydrogen are provided to only one selected module 200 while the remaining shutoff valves 134 are closed and the remaining modules 200 do not receive steam and hydrogen.

The needed fuel and health of the stacks 100 in the selected module 200 may be assessed (i.e., tested) by supplying a current to the stacks 100 to generate hydrogen and then measuring a voltage of the stacks 100. In particular, the testing process may include sensitivity analysis of the voltage of the stacks 100 to different fuel (i.e., steam) flow rates at a given current to determine sensitivity to the supplied fuel and health of the stacks 100 and to determine an optimum operating fuel (i.e., steam or water) utilization of the module 200. The shutoff valve 134 of the selected module 200 may then be closed after the reduction and testing steps, and the process may be repeated to sequentially reduce the fuel electrodes 7 in each remaining module 200 and assess each remaining module 200.

In one embodiment, once the fuel electrodes 7 have been reduced and in all of modules 200, and the stacks 100 in all of the modules 200 have been tested, the modules 200 may optionally be cooled to room temperature and then simultaneously restarted. In particular, the shutoff valves 134 of all modules 200 of the system 300 may be opened to provide steam to the modules 200 to heat the modules to operating temperature. The system steam mass flow controller 236 is controlled by the system controller 225 such that each of the modules 200 is provided with steam at substantially the same steam flow rate. In particular, the steam flow rate to each of the hotboxes 202 may vary by about 5% or less, such as by about 3% or less, by about 2% or less, or by about 1% or less, such as 0 to 0.5%. The flow restrictors 150 (if present in the modules 200) also ensure that each of the modules 200 is provided with steam at substantially the same steam flow rate.

In summary, a method of operating the system 300 includes: (i) opening a first one of the shutoff valves 134 located in a first one of the electrolyzer modules 200 to provide hydrogen and the steam from the system steam conduit 230 to a respective first one of the hotboxes 202 to reduce nickel oxide to nickel in cermet fuel electrodes 7 of the electrolyzer cells 1 located in the respective first stack 100 located in the respective first one of the hotboxes 202, and testing the respective first stack 100 by supplying a current to the respective first stack 100 to generate hydrogen and measuring a voltage of the first stack 100, while the remaining shutoff valves 134 are closed, and then (ii) closing the first one of the shutoff valves.

The steps (i) and (ii) can then be performed on a second electrolyzer module 200, and so on. Thus, the method includes sequentially performing steps (i) and (ii) on all of the electrolyzer modules 200 of the system 300 until the nickel oxide is reduced to the nickel in the cermet fuel electrodes 7 of the electrolyzer cells 1 located in all of the stacks 100 located in all of the hotboxes 202, and all of the stacks 100 are tested. After steps (i) and (ii) have been performed on all of the modules 200, the method further comprises simultaneously opening all of the shutoff valves 134 to provide steam to all of the stacks 100 to heat all of the stacks to a steady state operating temperature; and applying electric power (e.g., external current) to all of the stacks 100 to operate the stacks to generate the hydrogen product stream and the oxygen exhaust stream.

In one embodiment, if one or more of the modules 200 is faulted (i.e., does not pass the test during the testing step), the faulted module 200 may be taken offline by closing the corresponding shutoff valve 134 and/or 234, while the remaining modules 200 continue operating to generate hydrogen. In this embodiment, the method includes detecting a fault in a first one of the hotboxes 202 located in a first one of the electrolyzer modules 200; closing a first one of the shutoff valves 134 located in the first one of the electrolyzer modules 200; stopping providing electric power (e.g., the external current) to the first one of the hotboxes 202; and using the system steam mass flow controller 236 to reduce a steam flow rate in the system steam conduit 230 to compensate for the disconnection of the faulted electrolyzer module 200.

In one embodiment, different stacks 100 and/or different hotboxes 202 may receive a different amount of electric power (e.g., external current) depending on the condition of the stack or hotbox. For example, the amount of electric power (e.g., external current magnitude) may differ based on the degradation or aging of the stack(s) 100 in a respective hotbox 202, and/or based on whether stacks 100 in a particular hotbox are generating hydrogen. In this embodiment, the system steam mass flow controller 236 may control the steam flow rate in the system steam conduit 230 such that a steam utilization rate in all of the hotboxes 202 varies by less than 20%, such as by 10% or less, such as by 0 to 10%, for example by 1 to 5%. This prevents significant underutilization of steam in other hotboxes 202 when one hotbox 202 is operated at a lower steam utilization due to degradation or aging.

By utilizing a single system steam mass flow controller 236, provision of module steam mass flow controllers for each module 200 may be omitted. This simplifies the system 300 and reduces its maintenance and cost, while providing a consistent steam flow rate to each module 200.

Electrolyzer systems of various embodiments of the present disclosure provide a benefit to the climate by reducing greenhouse gas emissions and/or generating carbon-free fuel.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. An electrolyzer system, comprising:
a system steam conduit configured to receive steam from a steam source;
a system steam mass flow controller (MFC) located on the system steam conduit and configured to control steam flow through the system steam conduit; and
electrolyzer modules,
wherein each of the electrolyzer modules comprises:
a hotbox comprising a stack of electrolyzer cells configured receive a portion of the steam and configured to receive air, and wherein the stack outputs a hydrogen product stream and an oxygen exhaust stream during steady-state operation; and
a module steam conduit fluidly connecting the system steam conduit to the hotbox.

2. The electrolyzer system of claim 1, wherein each of the electrolyzer modules further comprises a shutoff valve located on the module steam conduit and configured to selectively stop steam flow through the module steam conduit.

3. The electrolyzer system of claim 2, wherein the shutoff valve comprises a pneumatic steam control valve.

4. The electrolyzer system of claim 2, wherein each of the electrolyzer modules further comprises a flow restrictor located on the module steam conduit and configured to restrict steam flow through the module steam conduit.

5. The electrolyzer system of claim 4, wherein:
each flow restrictor is configured to restrict steam flow such that a steam flow rate through the module steam conduit in each of the electrolyzer modules varies by less than 5%; and
each flow restrictor comprises a flow restrictor plate comprising at least one flow control orifice configured to generate a pressure drop in the corresponding module steam conduit.

6. The electrolyzer system of claim 4, wherein each of the electrolyzer modules further comprises a respective module cabinet housing the hotbox.

7. The electrolyzer system of claim 6, wherein:
the shutoff valve and the flow restrictor in each of the electrolyzer modules is located inside of the respective module cabinet and outside of the hotbox in the respective module cabinet;
the system steam conduit is fluidly connected to all of the module steam conduits of all of the electrolyzer modules; and
the system steam mass flow controller is located in a cabinet of a gas distribution module which is separate from the cabinets of the electrolyzer modules.

8. The electrolyzer system of claim 1, further comprising a system hydrogen conduit configured to provide hydrogen from a hydrogen storage vessel to the system steam conduit.

9. The electrolyzer system of claim 1, wherein:
the stack of electrolyzer cells comprises a stack of solid oxide electrolyzer cells; and
the electrolyzer modules do not have respective module steam mass flow controllers.

10. The electrolyzer system of claim 1, further comprising a system controller configured to control the system steam mass flow controller based on an operating condition of the electrolyzer system.

11. A method of operating an electrolyzer system, comprising:
providing steam from a steam source through a system steam conduit to module steam conduits located in respective electrolyzer modules;
controlling a flow rate of the steam through the system steam conduit using a system mass flow controller located on the system steam conduit;
providing portions of the steam to the module steam conduits and providing steam in the module steam conduits to respective stacks of electrolyzer cells located in respective hotboxes in the respective electrolyzer modules; and
operating the stacks to generate a hydrogen product stream and an oxygen exhaust stream.

12. The method of claim 11, wherein the system steam mass flow controller controls the steam flow rate such that the steam flow rates through the respective module steam conduits of the respective electrolyzer modules varies by less than 5%.

13. The method of claim 12, wherein the electrolyzer modules further comprise respective flow restrictors located on the respective module steam conduits and using the flow restrictors to generate pressure drops in the respective module steam conduits.

14. The method of claim 11, wherein the electrolyzer modules further comprise respective shutoff valves located on the respective module steam conduits.

15. The method of claim 14, further comprising:
(i) opening a first one of the shutoff valves located in a first one of the electrolyzer modules to provide hydrogen and steam from the system steam conduit to a respective first one of the hotboxes to reduce nickel oxide to nickel in cermet fuel electrodes of the electrolyzer cells located in the respective first stack located in the respective first one of the hotboxes, and testing the respective first stack by supplying a current to the respective first stack to generate hydrogen and measuring a voltage of the first stack, while the remaining shutoff valves are closed;
(ii) closing the first one of the shutoff valves;
(iii) opening a second one of the shutoff valves located in a second one of the electrolyzer modules to provide hydrogen and steam from the system steam conduit to a respective second one of the hotboxes to reduce nickel oxide to nickel in cermet fuel electrodes of the electrolyzer cells located in the respective second stack located in the respective second one of the hotboxes, and testing the respective second stack by supplying a current to the respective second stack to generate hydrogen and measuring a voltage of the second stack, while the remaining shutoff valves are closed; and
(iv) closing the second one of the shutoff valves.

16. The method of claim 15, further comprising sequentially performing steps (i) and (ii) on all of the electrolyzer modules of the system until nickel oxide is reduced to nickel in the cermet fuel electrodes of the electrolyzer cells located in all of the stacks located in all of the hotboxes, and all of the stacks are tested.

17. The method of claim 16, further comprising:
simultaneously opening all of the shutoff valves to provide steam to all of the stacks and to heat all of the stacks to a steady state operating temperature; and
applying electric power to all of the stacks to operate the stacks to generate hydrogen product streams and oxygen exhaust streams.

18. The method of claim 14, further comprising:
detecting a fault in a first one of the hotboxes located in a first one of the electrolyzer modules;
closing a first one of the shutoff valves located in the first one of the electrolyzer modules;
stopping providing electric power to the first one of the hotboxes; and
reducing a steam flow rate in the system steam conduit using the system mass flow controller.

19. The method of claim 11, further comprising applying a different amount of electric power to the stacks located in different ones of the hotboxes depending on conditions of the stacks or hotboxes, and using the system mass flow controller to control a steam flow rate in the system steam conduit such that a steam utilization rate in all of the hotboxes varies by less than 20%.

20. The method of claim 11, wherein:
the stacks comprise solid oxide electrolyzer cell stacks; and
the electrolyzer modules do not have respective module steam mass flow controllers.
